(19) United States
(12) Patent Application Publication
(10) Pub. No.: US 2006/0061216 A1
(43) Pub. Date: Mar. 23, 2006

(54) Power supply circuit for eliminating electrical interference

(76) Inventors: Chin-Wen Chou, Taipei Hsien (TW); Ying-Nan Cheng, Taipei Hsien (TW); Chin-Bian Chung, Taipei Hsien (TW)

Correspondence Address: BIRCH STEWART KOLASCH & BIRCH, PO BOX 747, FALLS CHURCH, VA, 22040-0747, US

(21) Appl. No.: 10/942,876

(22) Filed: Sep. 17, 2004

(51) Int. Cl. H02J 1/00

(52) U.S. Cl. 307/30

(57) ABSTRACT

Provided is a power supply apparatus in AV equipment. The apparatus is coupled to an AC input and comprises a first power circuit comprising a first rectifier coupled to the AC input for generating a rectified DC, a predetermined power supply unit, a first power supply unit being in parallel with the predetermined power supply unit and coupled to a grounded first load, and a switch coupled to both the power supply units; and a second power circuit being in parallel with the first power circuit and comprising a second rectifier coupled to the AC input for generating a rectified DC, and a second power supply unit coupled to a grounded second load. Both the first and second loads are activated by the first and second power supply units for prohibiting fluctuation voltage occurred on the second load from transmitting to and interfering with the first load.

### FIELD OF THE INVENTION

The present invention relates to power supply circuits and more particularly to such a power supply circuit, installed in an electronic device, capable of eliminating a potential electrical interference of one grounded load by grounding the other load independently in which the loads have different operating voltages.

### BACKGROUND OF THE INVENTION

A conventional power supply circuit of an AV (audio video) product such as LCD (liquid crystal display) or LCD TV (television) is shown in FIG. 1. An AC input is coupled to an external AC source. A rectifier including a plurality of diodes is coupled to the AC input and is adapted to convert AC voltage into DC one having a wavy waveshape. A power factor adjustment unit is coupled to the rectifier and is adapted to filter the DC output of the rectifier for obtaining a relatively smooth DC voltage. The smooth DC voltage is further fed to an inverter and a second driving loop in parallel therewith. DC is fed from the second driving loop to a second transformer for lowering DC voltage which is in turn fed to a grounded first load. Further, DC voltage is increased in the inverter prior to feeding to a grounded second load. The first load is a low voltage element such as an AD board, a speaker, etc. The second load is implemented as a cold cathode ray tube (CRT) for the display. The rectifier is in series with a default power supply including a first driving loop and a first transformer for supplying power to a coupled switch. A user may either press the switch to turn on or off the display and thus the power supply circuit or manipulate a remote control to perform the same.

In view of the above, power sources of both the loads are from the same rectifier and the driving loop. Also, both loads are grounded. The first load is required to operate in a low and stable DC voltage. Otherwise, it may be interfered, for example by fluctuation voltage occurred on the second load of high voltage, resulting in nipples and uneven hue on the display, poor speaker output quality, noise, etc. The interference is occurred because the voltage increase of the inverter is achieved by oscillating wave which adversely affects the first load via the common ground. That is, the first load is interfered by the voltage increase in the inverter. Such drawback is even serious in a large screen display of TV. Hence, a need for improvement exists.

### SUMMARY OF THE INVENTION

It is an object of the present invention to provide a novel power supply circuit having a first load of low voltage grounded and a second load of high voltage grounded independently. Also, the power supply circuit comprises two parallel power paths in which one is coupled to the first load via a first power circuit and the other one is coupled to the second load via a second power circuit. In brief, the grounding of the first load and the grounding of the second load are independent, resulting in the elimination of a potential electrical interference in the first load.

It is another object of the present invention to provide a power supply circuit in which a single switch is provided for turning on or off all components of an electronic device (e.g., AV product) incorporating the power supply circuit of the present invention in one operation without adversely affecting efficiency and quality of the display thereof.

The above and other objects, features and advantages of the present invention will become apparent from the following detailed description taken with the accompanying drawings.

### BRIEF DESCRIPTION OF THE DRAWINGS

FIG. 1 is a block diagram of a conventional power supply circuit of an AV product;

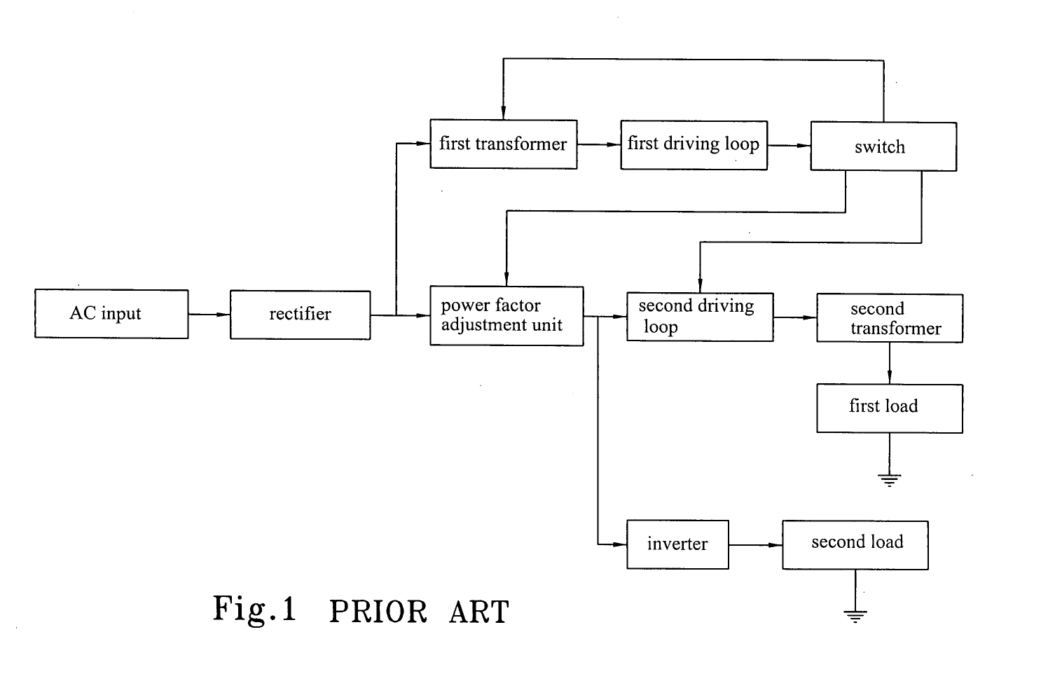

FIG. 2 is a block diagram of a preferred embodiment of power supply circuit of an AV product according to the invention;

FIG. 3 is a detailed block diagram of the power supply circuit shown in FIG. 2 according to a first preferred embodiment of the invention; and

FIG. 4 is a detailed block diagram of the power supply circuit shown in FIG. 2 according to a second preferred embodiment of the invention.

### DETAILED DESCRIPTION OF THE PREFERRED EMBODIMENTS

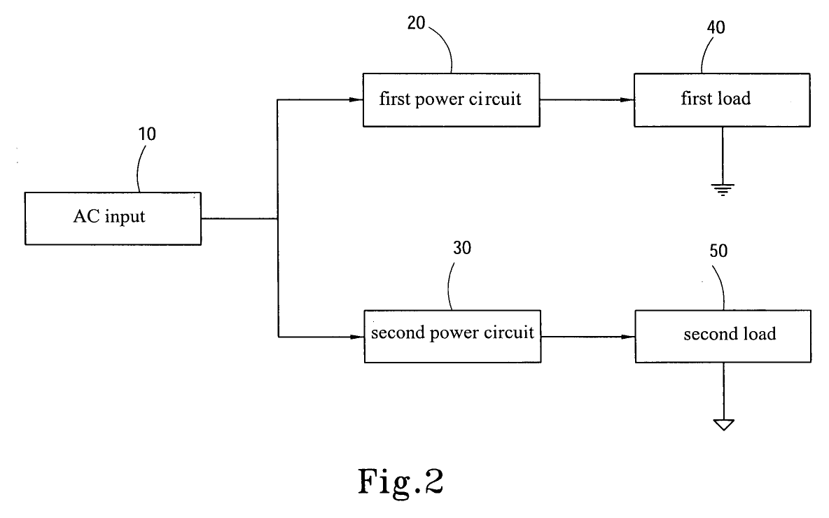

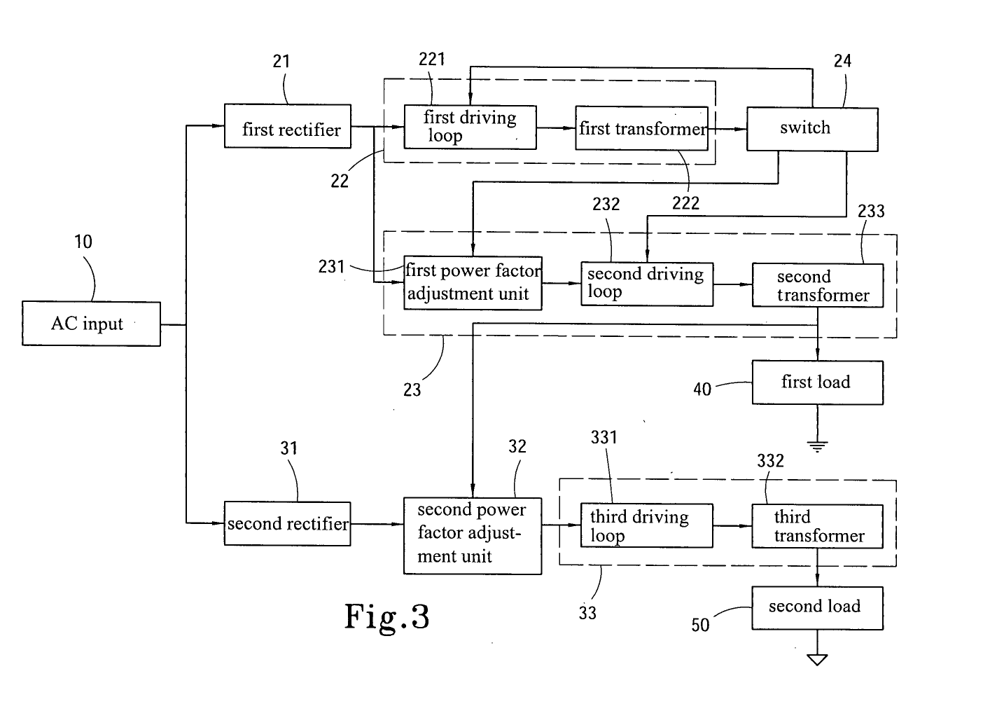

Referring to FIGS. 2 and 3, there is shown a power supply circuit constructed in accordance with a first preferred embodiment of the invention. The power supply circuit is installed in an AV product such as LCD or LCD TV. As shown, an AC input 10 is coupled to an external AC source. Two parallel power paths are extended from the AC input 10 in which one is coupled to a first load 40 via a first power circuit 20 and the other is coupled to a second load 50 via a second power circuit 30. The first power circuit 20 is adapted to convert AC into DC of low voltage and the second power circuit 30 is adapted to convert AC into DC of high voltage. Also, the grounding of the first load 40 and the grounding of the second load 50 are independent.

The first power circuit 20 comprises a first rectifier 21 coupled to the AC input 10, two parallel default power supply unit 22 and first power supply unit 23, and a switch 24 coupled to both the power supply units 22 and 23. The default power supply unit 22 comprises a first driving loop 221 for receiving rectified DC from the first rectifier 21 and outputting driving signals, and a first transformer 222 for lowering voltage. The first power supply unit 23 comprises a first power factor adjustment unit 231 for filtering the rectified DC, a second driving loop 232 for receiving the filtered DC and outputting driving signals, and a second transformer 233 for lowering voltage.

The second power circuit 30 comprises a second rectifier 31, a second power supply unit 33, and a second power factor adjustment unit 32 interconnected the second rectifier 31 and the second power supply unit 33 for filtering the DC output of the second rectifier 31 to obtain a relatively smooth DC voltage. The second power supply unit 33 is implemented as an inverter and comprises a third driving loop 331 coupled to the second power factor adjustment unit 32 and a third transformer 332 interconnected the third driving loop 331 and the second load 50. Note that the second power factor adjustment unit 32 may be eliminated in another embodiment. That is, the second rectifier 31 is coupled to the third driving loop 331 directly. DC voltage whether smooth (i.e., having second power factor adjustment unit 32) or not (i.e., no second power factor adjustment unit 32) is applied to the inverter (i.e., the second power supply unit 33) for increasing voltage.

As shown in FIG. 3, in response to turning on an electronic device (e.g., LCD or LCD TV) incorporating the power supply circuit of the invention, the switch 24 is closed to activate the first driving loop 221, the first power factor adjustment unit 231, and the second driving loop 232. Next, AC power fed from the AC input 10 is rectified by the first rectifier 21. The DC output is then filtered by the first power factor adjustment unit 231. The filtered DC is then supplied to the second driving loop 232 and the second transformer 233 sequentially. As an end, DC of low voltage is generated by the second transformer 233 (i.e., voltage decrease) prior to supplying to the first load 40 of low voltage such as AD board, speaker, or the like for activation. Output of the second transformer 233 is also fed to the second power factor adjustment unit 32 for activation. The activated second power factor adjustment unit 32 is adapted to filter DC. The filtered DC is then supplied to the third driving loop 331 and the third transformer 332 sequentially. As an end, DC of high voltage is generated by the third transformer 332 (i.e., voltage increase) prior to supplying to the second load 50 of high voltage such as cold CRT or the like for activation.

In view of above, the first load 40 and the second load 50 are activated by the first power supply unit 23 and the second power supply unit 33 respectively. That is, the first load 40 and the second load 50 are activated independently. As such, any fluctuation voltage occurred on the second load 50 of high voltage will not transmit to the first load 40 of low voltage. As a result, the first load 40 still can operate normally in a low operating voltage.

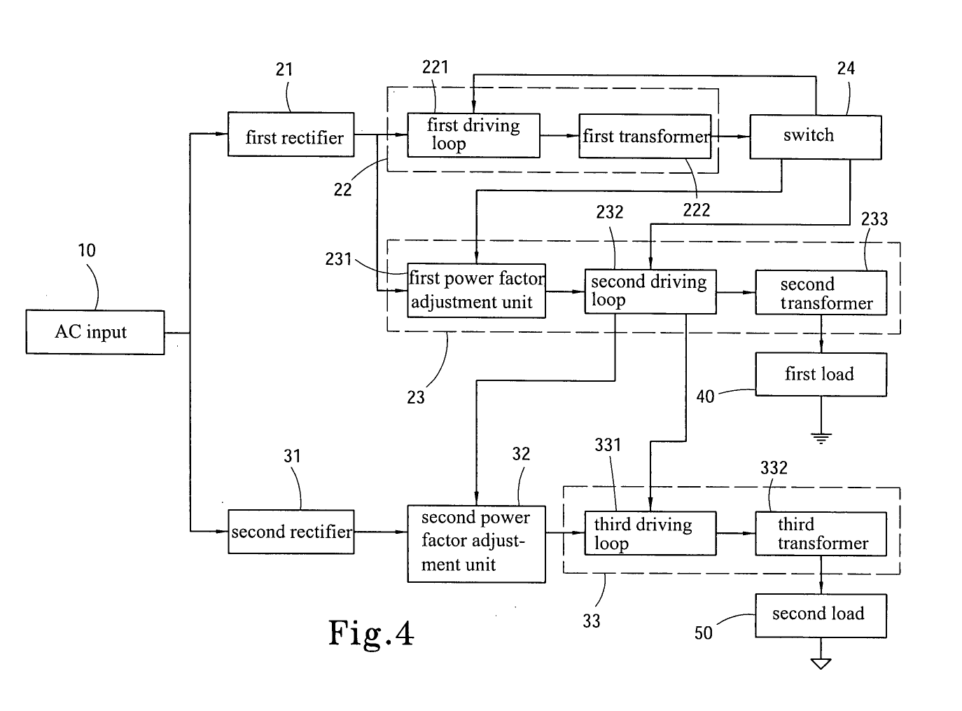

Referring to FIG. 4, a power supply circuit constructed in accordance with a second preferred embodiment of the invention is shown. The second preferred embodiment substantially has same structure as the first preferred embodiment. The differences between the first and the second preferred embodiments, i.e., the characteristics of the second preferred embodiment are detailed below. Both the second power factor adjustment unit 32 and the third driving loop 331 are activated by filtered DC output of the second driving loop 232. Likewise, the activated second power factor adjustment unit 32 is adapted to filter DC fed from the second rectifier 31. The filtered DC is then supplied to the third driving loop 331 and the third transformer 332 sequentially. As an end, DC of high voltage is generated by the third transformer 332 prior to supplying to the second load 50 for activation.

While the invention herein disclosed has been described by means of specific embodiments, numerous modifications and variations could be made thereto by those skilled in the art without departing from the scope and spirit of the invention set forth in the claims.

What is claimed is:

1. A power supply apparatus mounted in an AV equipment, the power supply apparatus being coupled to an AC input, comprising:
a first power circuit comprising a first rectifier coupled to the AC input for generating a rectified DC, a predetermined power supply unit, a first power supply unit being in parallel with the predetermined power supply unit and coupled to a grounded first load, and a switch coupled to both the power supply units; and
a second power circuit being in parallel with the first power circuit and comprising a second rectifier coupled to the AC input for generating a rectified DC, and a second power supply unit coupled to a grounded second load,
wherein the first load and the second load are activated by the first power supply unit and the second power supply unit respectively so as to prohibit fluctuation voltage occurred on the second load from transmitting to and interfering with the first load.

2. The power supply apparatus of claim 1, wherein the predetermined power supply unit comprises a first driving loop for receiving the rectified DC from the first rectifier and outputting a driving signal, and a first transformer for generating a lowered voltage output.

3. The power supply apparatus of claim 1, wherein the first power supply unit comprises a first power factor adjustment unit for filtering the rectified DC of the first rectifier, a second driving loop for receiving the filtered DC from the first power factor adjustment unit and outputting a driving signal, and a second transformer for generating a lowered voltage output.

4. The power supply apparatus of claim 3, wherein the voltage lowered by the second transformer is adapted to drive the first load.

5. The power supply apparatus of claim 3, wherein the switch is adapted to close to activate the first driving loop, the first power factor adjustment unit and the second driving loop; and wherein the voltage output of the second transformer is fed to the second power circuit for activation.

6. The power supply apparatus of claim 3, wherein the switch is adapted to close to activate the first driving loop, the first power factor adjustment unit and the second driving loop; and wherein the driving signal output of the second driving loop is fed to the second power circuit for activation.

7. The power supply apparatus of claim 1, wherein the second power supply unit is an inverter and comprises a third driving loop coupled to the second power factor adjustment unit, and a third transformer interconnected the third driving loop and the second load, the third transformer being adapted to generate an increased voltage output.

8. The power supply apparatus of claim 7, wherein the voltage increased by the third transformer is adapted to drive the second load.

9. The power supply apparatus of claim 7, further comprising a second power factor adjustment unit interconnected the second rectifier and the second power supply unit for filtering the rectified DC of the second rectifier.

10. A power supply apparatus mounted in an AV equipment, the power supply apparatus being coupled to an AC input, comprising:
a first power circuit comprising a first rectifier coupled to the AC input for generating a rectified DC, a predetermined power supply unit, a first power supply unit being in parallel with the predetermined power supply unit and coupled to a grounded first load, and a switch coupled to both the power supply units; and
a second power circuit being in parallel with the first power circuit and comprising a second rectifier coupled to the AC input for generating a rectified DC, and a second power supply unit coupled to a grounded second load,
wherein the first load and the second load are activated by the first power supply unit and the second power supply unit respectively, wherein the switch is adapted to close to activate the predetermined power supply unit and the first power circuit, and wherein the activated first power circuit is adapted to activate the second power circuit so as to prohibit fluctuation voltage occurred on the second load from transmitting to and interfering with the first load.

11. A power supply apparatus mounted in an AV equipment, the power supply apparatus being coupled to an AC input, comprising:
a first power circuit comprising a first rectifier coupled to the AC input for generating a rectified DC; and
a second power circuit being in parallel with the first power circuit and comprising a second rectifier coupled to the AC input for generating a rectified DC,
wherein the first power circuit is adapted to generate a lowered voltage and apply the same to the first load, and the second power circuit is adapted to generate an increased voltage and apply the same to the second load so as to prohibit fluctuation voltage occurred on the second load from transmitting to and interfering with the first load.

12. The power supply apparatus of claim 11, wherein the first load is an AD board.

13. The power supply apparatus of claim 11, wherein the second load is a cold CRT.
